(19) United States
(12) Patent Application Publication
(10) Pub. No.: US 2009/0227382 A1
(43) Pub. Date: Sep. 10, 2009

(54) PINION SHAFT FORMED WITH AN INTEGRAL INNER RACE OF A CONSTANT VELOCITY JOINT

(76) Inventor: Matthew P. BLECKE, Toledo, OH (US)

Correspondence Address: BERENATO, WHITE & STAVISH, LLC, 6550 ROCK SPRING DRIVE, SUITE 240, BETHESDA, MD, 20817, US

(21) Appl. No.: 12/043,337

(22) Filed: Mar. 6, 2008

(51) Int. Cl. F16D 3/00

(52) U.S. Cl. 464/145

(57) ABSTRACT

A vehicle driveline assembly including a drive shaft; a pinion shaft and a constant velocity joint coupling the drive shaft to the pinion shaft. The constant velocity joint has an inner race integrally formed on an end of the pinion shaft.

### BACKGROUND OF THE INVENTION

a) Field of the Invention

This invention relates generally to a vehicle drivelines utilizing constant velocity joints.

b) Description of Related Art

Conventional vehicle differential gear assemblies transfer rotational torque from a rotary driver member such as the output shaft of a change gear transmission to a pair of rotary driven members such as a pair of substantially axially aligned spaced-apart axle shafts mounted for rotation and having wheels mounted on their respective outboard ends. The differential gear assembly is driven by a pinion gear which in turn is coupled to a driveline component (propeller shaft) of a vehicle.

In many convention configurations of a vehicle's driveline, a universal joint is connected to the input shaft of the drive pinion gear by way of a yoke welded to each end of the propeller shaft. This arrangement of power transfer components ideally serves to compensate for any changes in the driveline. However, with such an arrangement, the power transfer may not be as efficient as possible between the propeller shaft and the differential. In one prior art arrangement, U.S. Pat. No. 5,916,055, the drive bevel pinion also acts as the outer race of a constant velocity joint. However, this arrangement requires drastic modification to the differential housing, bearings, seals and other component which increases the size and weight of the entire differential axle assembly and otherwise prohibits retrofit, or incorporation into standard axle assemblies and their associated housings.

### SUMMARY OF THE INVENTION

The present invention is directed to a vehicle driveline assembly including: a drive shaft; a pinion shaft and a constant velocity joint coupling the drive shaft to the pinion shaft. The constant velocity joint has an inner race integrally formed on an end of the pinion shaft. The pinion shaft and associated pinion gear drive an axle assembly.

### BRIEF DESCRIPTION OF THE DRAWINGS

FIG. 1 is a schematic layout of a vehicle drive system incorporating the pinion shaft and constant velocity joint.

FIG. 2 is a cross-sectional view of the constant velocity joint with integrated inner race and pinion shaft of an axle assembly.

### DESCRIPTION OF PREFERRED EMBODIMENT

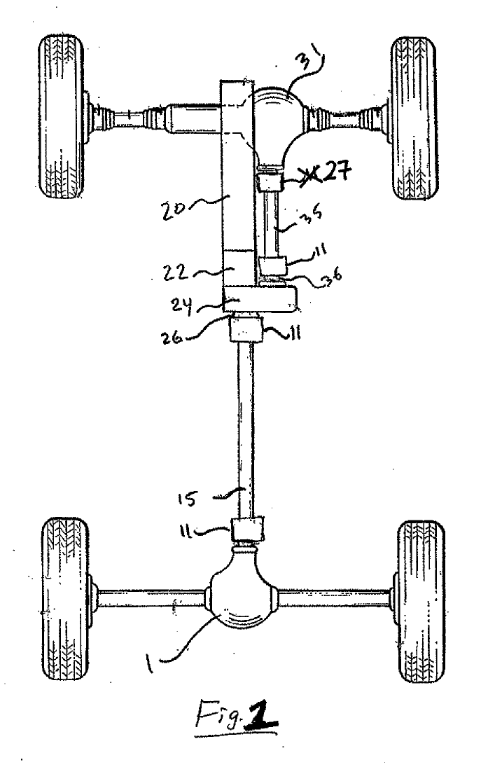

FIG. 1 depicts a drive train of an all-wheel drive (AWD) or four-wheel drive (4WD) motor vehicle in accordance with an embodiment of the present invention. The AWD drive train comprises an internal combustion engine 20 mounted to a front end of the motor vehicle and coupled to a transmission unit 22. A transfer case 24 is secured to the rear of the transmission unit 22. The transmission unit 22 is connected to an input shaft (not shown) of the transfer case 24. The transfer case 24 includes a rear output shaft or yoke 26 connected to a forward end of a rear drive shaft 15 by a constant velocity joint coupling 11. The rearward end of the rear drive shaft 15 is coupled to an pinion shaft 3 of a rear differential assembly 2 by means another constant velocity joint as shown in FIG. 1. As previously discussed, the rear differential 1 is adapted to provide torque from the rear drive shaft 14 to output shafts which in turn rotate the rear wheels.

The transfer case 24 includes a front output shaft or yoke 36 connected to a forward end of a front drive shaft 35 by a constant velocity joint coupling 11. The front drive shaft 35 has a forward end connected to an input shaft or yoke of a front differential unit 31 of a front (secondary) on-demand axle assembly by means of another constant velocity joint coupling 27 and is adapted to divide torque received from the drive shaft 35 between the vehicle front wheels.

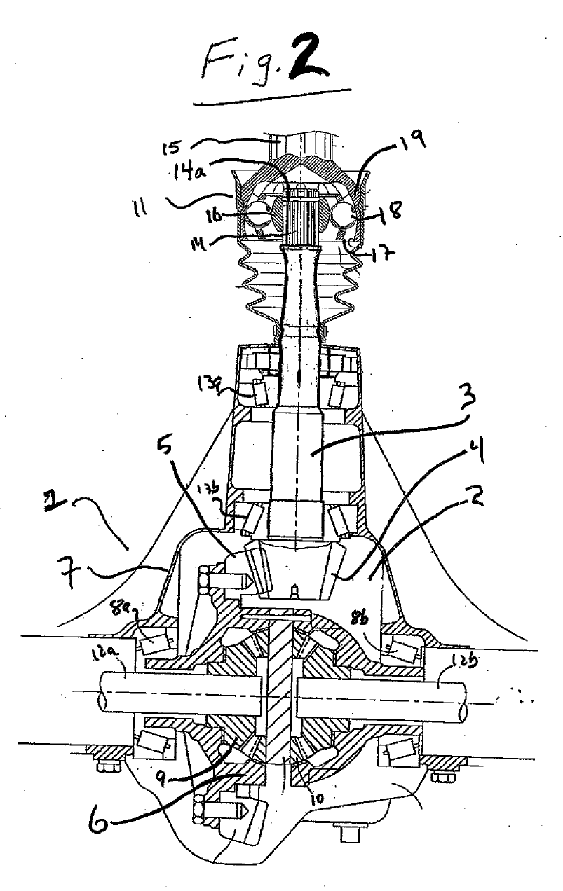

FIG. 2 is depicts an axle assembly 1 having an active differential assembly 2. A pinion shaft 3 is connected to a pinion gear 4 which engagable drives a ring gear 5 in a conventional manner. The ring gear 5 is connected to a differential case 6 rotatably mounted within the housing 7 via bearings 8a, 8b. The differential case 6 contains a gear set (side gears 9 and spider gears 10, etc.) to allow differential rotational speed between a pair of opposing output shafts 12a, 12b. The details of the operation of conventional differential assemblies will not be further elaborated as such is well within the knowledge of one of ordinary skill in the art.

The pinion shaft 3 is rotatably mounted and extends through the housing 7 via bearings 13a, 13b and is sealed in a conventional manner. The pinion gear 4 may be unitarily formed with the pinion shaft 3. As previously discussed, the pinion shaft 3 is connected to the drive shaft 15 via constant velocity joint 1. The end of the pinion shaft 3, opposite the pinion gear 4, is splined 14 to receive a complimentarily splined inner race 16. A clip 14a may be employed to secure the longitudinal position of the inner race 16 with respect to the pinion shaft 3. The inner race may also be formed integrally with the pinion shaft 3 by other techniques such as unitarily forming the inner race with the pinion shaft 3.

As shown in FIG. 2, the constant velocity joint is a fixed center ball and cage type constant velocity universal joint. The ball and cage assembly includes cage 17 having a plurality of balls 18 rotatably seated therein. The cage and ball assembly is disposed between the inner race 16 of the pinion shaft 3 and the outer race 19 of the constant velocity joint. The assembly provides improved articulation between the pinion shaft 3 and drive shaft 15 during rotation. Integrally forming the inner race 16 to the pinion shaft 16 provides for improved assembly techniques, more compact arrangement and efficient torque transfer between the drive shaft 15 and pinion shaft 3. As can also be seen a boot assembly is secured to the outer race and pinion shaft 3 to prohibit entrance of foreign matter such as dust, dirt and the like.

The foregoing invention has been shown and described with reference to a preferred embodiment. However, it will be understood by those skilled in the art that various changes in form and detail may be made therein without departing from the spirit and scope of the invention.

1. An vehicle driveline assembly comprising:
a drive shaft;
a pinion shaft having first and second ends;
a constant velocity joint having an inner race and an outer race, said joint coupling said driveshaft to said pinion shaft;
an axle assembly;
a pinion gear for driving said axle assembly, said pinion gear disposed on a first end of said pinion shaft, wherein said inner race of said constant velocity joint is integrally formed on a second end of said pinion shaft.

2. The axle assembly according to claim 1, wherein, said inner race of said constant velocity joint is formed as a sleeve having a splined inner surface disposed about and engaging a corresponding splined outer surface of said pinion shaft.

3. The axle assembly according to claim 1, wherein said constant velocity joint is a fixed center ball and cage type constant velocity universal joint, said constant velocity joint including;
an outer race positively connected to said drive shaft, and
a cage and plurality of balls disposed between said inner and outer races, said constant velocity joint thereby providing articulating movement of said drive shaft to said pinion shaft while simultaneously rotating together.

4. The axle assembly according to claim 1, wherein said pinion gear is integrally formed with said pinion shaft as a single piece.
